(19) United States
(12) Patent Application Publication
(10) Pub. No.: US 2017/0262383 A1
(43) Pub. Date: Sep. 14, 2017

(54) ELECTRONIC APPARATUS AND CONTROL METHOD THEREOF

(71) Applicant: SAMSUNG ELECTRONICS CO., LTD., Suwon-si (KR)

(72) Inventors: Ki-hun LEE, Jeonju-si (KR); Jong-oh HUR, Seoul (KR); Ji-hoon KIM, Seoul (KR); Jin-bum PARK, Anyang-si (KR); Dong-uk KIM, Suwon-si (KR)

(21) Appl. No.: 15/440,283

(22) Filed: Feb. 23, 2017

(30) Foreign Application Priority Data
Mar. 9, 2016 (KR) 10-2016-0028467

(51) Int. Cl. G06F 12/14

(52) U.S. Cl. CPC G06F 12/1425; G06F 2212/1052

(57) ABSTRACT

An electronic apparatus and a control method thereof are provided. The electronic apparatus includes a memory having a protection area and storing data of a first operating system (OS) and at least one first program involved with first OS in the protection area; at least one processor configured to execute the at least one first program and at least one second program involved with a second OS having an authority higher than the first OS; and a memory monitor comprising circuitry configured to detect whether an access to the protection area of the memory occurs, to interrupt the access if the access occurs, and to perform a security verification of the data stored in the protection area. The electronic apparatus may guarantee and/or improve integrity thereof using a hardware device, which can directly monitor the memory at a CPU environment in which a security area and a general area are separated.

### CROSS-REFERENCE TO RELATED APPLICATION

This application is based on and claims priority under 35 U.S.C. §119 to Korean Patent Application No. 10-2016-0028467, filed on Mar. 9, 2016 in the Korean Intellectual Property Office, the disclosure of which is incorporated by reference herein in its entirety.

### BACKGROUND

Field

The present disclosure relates generally to an electronic apparatus and a control method thereof, and for example, to an electronic apparatus and a control method thereof, which can prevent and/or reduce software hacking by monitoring a memory.

Description of Related Art

To verify integrity in an operating system of a terminal, hitherto a trap is set in advance for a main operation related with security at a general area of a central processing unit (CPU), and if an event to the main operation occurs, information on event occurrence is transmitted to a security area of the CPU to perform a verification to the event. Also, whenever data is read out from or written to a wrong address space of the memory, information on data read or write is transmitted to the security area to perform a verification to the data.

In this case, if due to frequent event occurrences to the main operation, the information thereon is frequently transmitted to the security area, the terminal may not guarantee normal operation. Also, since processor resources are consumed in information transmission, the terminal may be degraded in performance.

In another example of the related art, a static memory area of a memory is monitored using a hardware device capable of directly monitoring the memory at a CPU environment in which a single domain or area exists, and if a value of the memory area is changed, information on changed value is transmitted to an external integrity verification device to perform a verification thereto. In this case, since the external integrity verification device is used, it is difficult to apply the related art to a small mobile terminal. Also, even if an internal integrity verification device is used, there is a problem in that since the verification takes place at the single domain, it is difficult to guarantee integrity of verification environment.

### SUMMARY

Various example embodiments of the present disclosure address at least the above problems and/or disadvantages and other disadvantages not described above.

The example embodiments may provide an electronic apparatus and a control method thereof, which use a hardware device capable of directly monitoring a memory at a CPU environment in which a security area and a general area are separated, thereby guaranteeing and/or improving integrity of the electronic apparatus.

Also, the example embodiments may provide an electronic apparatus and a control method thereof, which if an access to a protection area of a memory occurs, can interrupt the access and perform a security verification to the protection area of the memory.

According to an example aspect of an example embodiment, an electronic apparatus is provided, the electronic apparatus including a memory configured to include a protection area and to store data of a first operating system (OS) and at least one first program involved with first OS in the protection area; at least one processor configured to execute the at least one first program and at least one second program involved with a second OS having an authority higher than the first OS; and a memory monitor configured to detect whether an access to the protection area of the memory occurs, to interrupt the access if the access occurs, and to perform a security verification to the data stored in the protection area.

According to an example embodiment, the electronic apparatus may guarantee and/or improve integrity thereof using the hardware device, which can directly monitor the memory at a CPU environment in which a security area and a general area are separated. Also, if the access to the protection area of the memory occurs, the electronic apparatus interrupts the access and performs the security verification at safe environment, thereby guaranteeing and/or improving integrity of verification environment.

The at least one processor may be configured to execute a security program for monitoring the protection area of the memory. Accordingly, the electronic apparatus may request the memory monitor to detect whether the protection area of the memory is altered and receive the detected result from the memory monitor to perform the security verification.

The memory monitor may be configured to transmit information on access occurrence to the security program if the access to the protection area of the memory occurs. For this reason, if the access, such as read, write, execution or the like, to data stored in the protection area of the memory is detected, the electronic apparatus may transmit information on detected access to the security program to perform the security verification.

The information on access occurrence may include an address and a data value for the protection area of the memory that the access has occurred.

The memory monitor may be configured to store the information on access occurrence in a register and to generate an interrupt request to transmit to the security program. With this, if the access to the protection area of the memory occurs, the electronic apparatus may store the address and the data value on the protection area of the memory that the access has occurred in the register, and enable the security program to read out the value stored in the register.

The security program may include a manager program configured to send and receive information on the protection area of the memory to and from the memory monitor, and a verification program configured to perform the security verification based on the information on access occurrence transmitted from the memory monitor. According to this, the electronic apparatus may implement by separate programs, a function of setting the protection area of the memory and receiving the information on access occurrence to the protection area of the memory from the memory monitor and a function of performing the security verification to the protection area of the memory based on the information on access occurrence, thereby improving performance of integrity verification.

The security program may be executed by a support of the second OS. Accordingly, the electronic apparatus may implement the program for security verification at safer CPU environment, thereby guaranteeing integrity to verification environment.

The manager program may be configured to set the protection area of the memory according to a request of the verification program. With this, the electronic apparatus may use information for setting and verification of the protection area transmitted with being encoded to the security area in boot time of the electronic apparatus, in order to set the protection area of the memory to be monitored by the memory monitor.

The manager program may be configured to set at least one of a static memory protection area and a dynamic memory protection area according to the request of the verification program. According to this, the electronic apparatus may detect an abnormal access occurrence to the dynamic memory protection area, as well as an access occurrence to the static memory protection area.

The at least one processor may be configured to set at least one operation on the at least one first program and to execute an operation monitoring program, which determines whether the set operation is altered. Accordingly, the electronic apparatus may detect an alteration presence to a specific operation from among a plurality of operations about the at least one first program executed at the general area of the CPU, thereby determining whether there is an attack by a third program.

According to an example aspect of another example embodiment, a control method of an electronic apparatus is provided, including: storing data of a first operating system (OS) and at least one first program involved with first OS in a protection area of a memory by at least one processor; executing the at least one first program and at least one second program involved with a second OS having an authority higher than the first OS; and detecting whether an access to the protection area of the memory occurs using a memory monitor; interrupting the access to the protection area if the access occurs; and performing a security verification of the data stored in the protection area using the memory monitor.

According to an example embodiment, the electronic apparatus may guarantee and/or improve integrity thereof using the hardware device, which can directly monitor the memory at a CPU environment in which a security area and a general area are separated. Also, if the access to the protection area of the memory occurs, the electronic apparatus interrupts the access and performs the security verification at safe environment, thereby guaranteeing integrity to verification environment.

The at least one processor may be configured to execute a security program for monitoring the protection area of the memory. Accordingly, the electronic apparatus may request the memory monitor to detect whether the protection area of the memory is altered and receive the detected result from the memory monitor to perform the security verification.

The method may further include transmitting information on access occurrence to the security program by the memory monitor if access to the protection area of the memory occurs. For this reason, if the access, such as read, write, execution or the like, to data stored in the protection area of the memory is detected, the electronic apparatus may transmit information on detected access to the security program to perform the security verification.

The information on access occurrence may include an address and a data value for the protection area of the memory that the access has occurred.

The method may further include storing the information on access occurrence in a register and generating an interrupt request to transmit to the security program, by the memory monitor. With this, if the access to the protection area of the memory occurs, the electronic apparatus may store the address and the data value on the protection area of the memory that the access has occurred in the register, and enable the security program to read out the value stored in the register.

The security program may include a manager program configured to send and receive information on the protection area of the memory to and from the memory monitor, and a verification program configured to perform security verification based on the information on access to the protection area occurrence transmitted from the memory monitor. According to this, the electronic apparatus may implement by separate programs, a function of setting the protection area of the memory and receiving the information on access occurrence to the protection area of the memory from the memory monitor and a function of performing the security verification to the protection area of the memory based on the information on access occurrence, thereby improving performance of integrity verification.

The security program may be executed by a support of the second operating system. Accordingly, the electronic apparatus may implement the program for security verification at safer CPU environment, thereby guaranteeing integrity to verification environment.

The method may further include setting the protection area of the memory based on a request of the verification program, by the manager program. With this, the electronic apparatus may use information for setting and verification of the protection area transmitted with being encoded to the security area in boot time of the electronic apparatus, to set the protection area of the memory to be monitored by the memory monitor.

The method may further include setting at least one of a static memory protection area and a dynamic memory protection area based on the request of the verification program, by the manager program. Thus, the electronic apparatus may detect an abnormal access occurrence to the dynamic memory protection area, as well as an access occurrence to the static memory protection area.

The method may further include setting at least one operation on the at least one first program and executing an operation monitoring program, which determines whether the set operation is altered, by the at least one processor. Accordingly, the electronic apparatus may detect an alteration presence to a specific operation from among a plurality of operations about the at least one first program executed at the general area of the CPU, thereby determining whether there is an attack by a third program.

As described above, according to the example embodiments, the electronic apparatus uses the hardware device capable of directly monitoring the memory at the CPU environment in which the security area and the general area are separated, thereby enabling to immediately detect whether the protection area of the memory is altered or tampered and enabling immediate attention without changing or correcting the existing OS.

Further, according to the example embodiments, the electronic apparatus performs the security verification at the safe environment, thereby guaranteeing and/or improving integrity to verification environment.

Also, according to the example embodiments, the electronic apparatus enables unidirectional information exchange between the general area and the security area of the CPU, thereby reducing a risk of man-in-the-middle attack capable of being generated in bidirectional communication.

### BRIEF DESCRIPTION OF THE DRAWINGS

The above and other aspects, features, and attendant advantages of the present disclosure will be more apparent and readily appreciated from the following detailed description, taken in conjunction with the accompanying drawings, in which like reference numerals refer to like elements, and wherein:

FIG. 1 is a block diagram illustrating an example electronic apparatus according to an example embodiment;

FIG. 2 is a block diagram illustrating an example display apparatus according to an example embodiment;

FIG. 3 is a diagram illustrating an example construction for performing memory monitoring and security verification according to an example embodiment;

FIG. 4 is a diagram illustrating another example construction for performing memory monitoring and security verification according to an example embodiment;

FIG. 5 is a diagram illustrating an example process of performing memory monitoring and security verification according to an example embodiment;

FIG. 6 is a diagram illustrating another example process of performing memory monitoring and security verification according to an example embodiment;

FIG. 7 is a diagram illustrating another example process of performing memory monitoring and security verification according to an example embodiment; and

FIG. 8 is a flowchart illustrating an example control method of an electronic apparatus according to an example embodiment.

Throughout the drawings, like reference numerals will be understood to refer to like parts, components, and structures.

### DETAILED DESCRIPTION

With reference to accompanying drawings, various example embodiments will be described in greater detail to aid in understanding the present disclosure. The example embodiments may be achieved in various forms, and are not limited to the embodiments provided herein. To clearly describe the example embodiments, those unrelated to the description have been omitted, and like reference numerals denote like elements throughout this specification.

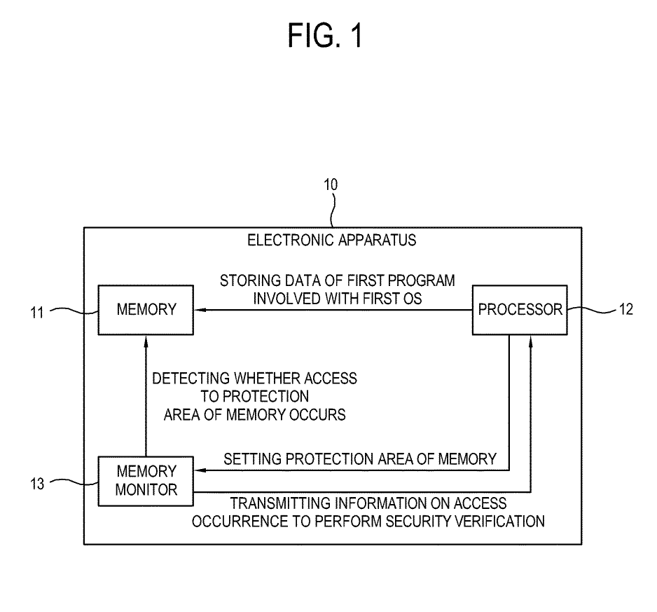

Hereinafter, an electronic apparatus according to an example embodiment will be described in greater detail with reference to FIG. 1. FIG. 1 is a block diagram illustrating an example electronic apparatus according to an example embodiment. As illustrated in FIG. 1, the electronic apparatus 10 according to an example embodiment includes a memory 11, a processor 12 and a memory monitor 13. The electronic apparatus 10 according to an example embodiment may be implemented, for example, as a smart television (TV), a smart phone, a tablet personal computer (PC), a computer, a notebook computer, or the like, but is not limited thereto. As another example, the electronic apparatus 10 according to an example embodiment may be implemented as general home appliances, industrial electronic devices, or the like, which include a computing system, but is not limited thereto. Construction included in the electronic apparatus 10 according to an example embodiment are not limited to the example embodiment as described above, and may be implemented including additional other components.

The electronic apparatus 10 according to an example embodiment executes programs, such as applications, at a CPU environment which is divided into a general area and a security area. The general area and the security area are divided according to an operating state of the CPU, each of which spaces for addresses and registers related with page table are separated.

Different types of operating systems (OSs) may be driven at the general area and the security area, respectively. For instance, an OS, which is sufficiently verified and is strong on security, may be driven at the security area, whereas an OS, which is difficult to verify, but more commonly used, may be driven at the general area. Operations, which are processed at the general area, may include, for example, play back of unencrypted channels, execution of general applications, processing of multimedia data, etc. Also, Operations, which are processed at the security area, may include, for example, processing of important personal information data, processing of encrypted data, etc.

The electronic apparatus 10 stores in a protection area, data of a first OS and at least one first program involved with the first OS, which are executed at the general area, at the CPU environment divided into the general area and the security area. By at least one processor 12, the electronic apparatus 10 executes the at least one first program and at least one second program involved with a second OS having an authority higher than the first OS. By the memory monitor 13, the electronic apparatus 10 detects whether an access to the protection area of the memory 11 occurs and if the access occurs, interrupts the access. Also, by the memory monitor 13, the electronic apparatus 10 performs at security verification to the data stored in the protection area of the memory 11.

According to the example embodiment as described above, the electronic apparatus may guarantee and/or improve integrity thereof using the hardware device, which can directly monitor the memory at the CPU environment in which the security area and the general area are separated. Also, if the access to the protection area of the memory occurs, the electronic apparatus may interrupt the access and perform the security verification at the safe environment, thereby guaranteeing integrity to verification environment.

The memory 11 may, for example, include a volatile storage medium that requires electrical supply to maintain stored information. As an example, the memory 11 may be implemented as a random access memory (RAM). The memory 11 is provided with the protection area, and stores data of the first OS and the at least one first program involved with the first OS, in the protection area. The protection area of the memory 11 may be set as a static memory protection area or a dynamic memory protection area. The protection area of the memory 11 may be set by information transmitted to the security area of the CPU with being encoded in boot time of the electronic apparatus. At this time, the information transmitted to the security area as information for setting and verification of the protection area is decoded at the security area.

The first OS as an OS driven in the general area corresponds to an OS, which is difficult to verify, but more commonly used. The at least one first program is implemented as a general program, which is executable with a support of the first OS. Since the memory 11 stores execution codes and data related with the first program, there is a risk of malicious hacking attempt thereto and it is therefore necessary to monitor the memory 11.

The at least one processor 12 executes at least one first program and at least one second program involved with a second OS having an authority higher than the first OS. Here, the at least one first program may be implemented as a general program, which is executed by the first OS at the general area of the CPU. The at least one second program may be implemented as a security required program, which is executed by the second OS having the authority higher than the first OS at the security area of the CPU.

The memory monitor 13 may include various circuitry and/or program elements that detect whether an access to the protection area of the memory 11 occurs and if the access occurs, interrupts the access to the protection area of the memory 11. Also, the memory monitor 13 performs a security verification to data stored in the protection area of the memory 11. As an example embodiment, the memory monitor 13 may implemented by a separate hardware in the electronic apparatus 10. Since if the memory monitor 13 is implemented by the hardware, there is no data loaded on the memory 11, the memory monitor 13 is more excellent in performance, as compared with if the memory monitor 13 is implemented by a software. Also, if the memory monitor 13 is implemented by the hardware, it is possible to detect alteration or tampering of the memory 11 in real time and to immediately response thereto. However, implemented type of the memory monitor 13 is not limited thereto. For instance. If the CPU is excellent in performance and processing speed, the memory monitor 13 may be implemented by a software, which is executed by the first OS or the second OS.

As an example embodiment, the at least one processor 12 may execute a security program for monitoring the protection area of the memory 11. The security program may be executed with a support of the second OS at the security area of the CPU. Accordingly, the electronic apparatus may execute the program for security verification at safer CPU environment, thereby guaranteeing integrity to verification environment.

If the access to the protection area of the memory 11 occurs, the memory monitor 13 may transmit information on the access occurrence to the security program. Here, the information on the access occurrence may include an address and a data value for the protection area of the memory that the access has occurred. In other words, if the access, such as read, write, execution and the like, to data stored in the protection area of the memory 11 is detected, the memory monitor 13 may transmit information including the address, the data value and the like that the access has been detected, to the security program executed by the second OS, thus to perform security verification at safe environment.

As an example embodiment, the memory monitor 13 may store the information on the access occurrence in a register and generate an interrupt request to transmit to the security program. For instance, if the access, such as read, write, execution and the like, to data stored in the protection area of the memory 11 is detected, the memory monitor 13 may store an address that the access has been detected, in the register and generate a fast interrupt request (FIQ) to transmit to the security program. The security program may read the address stored in the register based on the FIQ transmitted from the memory monitor 13 and perform a verification on whether there is an attack by hacking or the like, via information for preset verification.

As an example embodiment, the security program may include a manager program, which sends and receives information on the protection area of the memory 11 to and from the memory monitor 13, and a verification program, which performs a security verification based on the information on access occurrence transmitted from the memory monitor 13.

As an example embodiment, the manager program may set the protection area of the memory 11 based on a request of the verification program. In order words, the manager program may set the protection area of the memory 11 that the memory monitor 13 has to monitor, and transmit information on the set protection area of the memory 11 to the memory monitor 13. Also, the manager program may receive the information on access occurrence to the protection area of the memory 11 from the memory monitor 13, and transmit the received information to the verification program to perform security verification.

As another example embodiment, the manager program may set at least one of a static memory protection area and a dynamic memory protection area according to a request of the verification program. As an example, if the static memory protection area is set, the memory monitor 13 may detect whether the protection area is altered or tampered to verify whether there is an attack by hacking or the like. As another example, if the dynamic memory protection area is set, the memory monitor 13 may detect whether the protection area is irregularly altered or tampered to verify whether there is an attack by hacking or the like.

As an example embodiment, the verification program may request the manager program a setting of the memory protection area, based on the information for setting and verification of the memory protection area transmitted with being encoded in boot time of the electronic apparatus. Also, the verification program may verify whether there is an attack by hacking or the like, based on the information on access occurrence to the protection area of the memory 11 transmitted from the manager program. Also, the verification program may generate and store or register a report to the verified result.

As an example embodiment, the at least one processor 12 may set at least one operation on the at least one first program, and execute an operation monitoring program, which determines whether the set at least one operation is altered or tampered. The operation monitoring program may be implemented, so that it is executed by the first OS at the general area of the CPU. As an example, the operation monitoring program may set at least one main operation from among a plurality of operations about the first program, which is executed by the first OS, and if the set main operation is abnormally executed, store or register an address and a data value therefor in a specific area of the memory 11.

With the execution result of the operation monitoring program as described above, if the memory monitor 13 detects an access to the specific area of the memory 11, the memory monitor 13 may store the address and the data value that the access is detected, in the register and generate the FIQ to transmit to the security program. Accordingly, the security program may read out the address stored in the register based on the FIQ transmitted from the memory monitor 13, and perform the verification on whether there is an attack by hacking or the like via the information for preset verification.

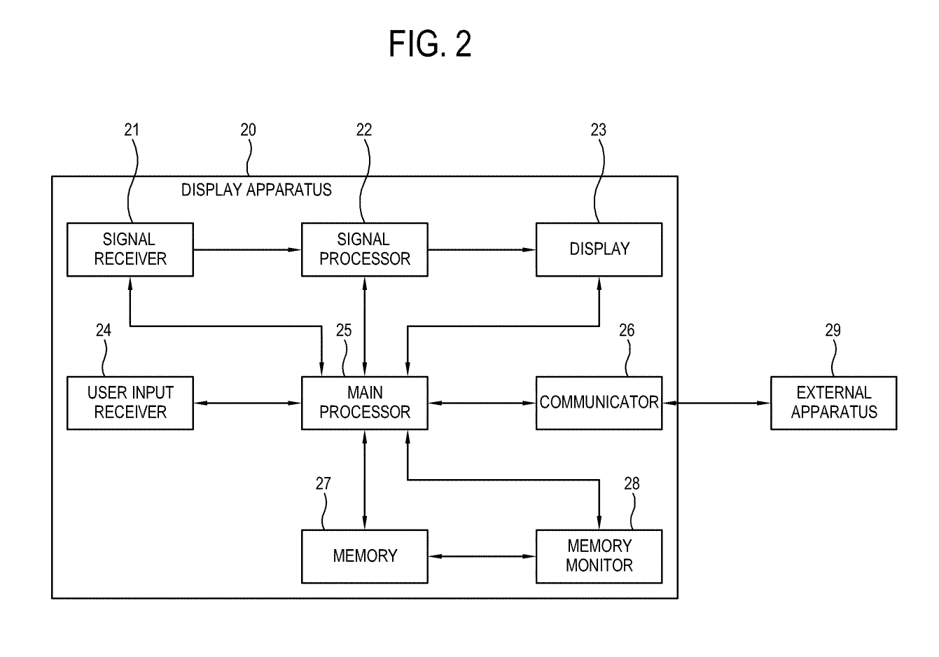

FIG. 2 is a block diagram illustrating an example construction of an example display apparatus according to an example embodiment. As illustrated in FIG. 2, the display apparatus 20 according to an example embodiment includes a signal receiver 21, a signal processor 22, a display 23, a user input receiver 24, a main processor 25, a communicator (e.g., including communication circuitry) 26, a memory 27 and a memory monitor 28. The display apparatus 20 according to an example embodiment may be implemented as, for example, a smart TV, a smart phone, a tablet PC, a computer, a notebook computer, or the like, but is not limited thereto. The display apparatus 20 may be connected an external apparatus 29 by a local area network (LAN) system, such as, Bluetooth (BT), wireless fidelity (Wi-Fi), Zigbee and so on, or by an internet network using TCP/IP. The external apparatus 29 may be implemented as a display apparatus, such as a smart TV, a smart phone, or the like, or a home appliance, such as an air conditioner, a washing machine, a refrigerator, a robot cleaner, or the like, but is not limited thereto. The types of the external apparatus 29 are not limited thereto, but may be implemented by various kinds of electronic devices. Since the main processor 25, the memory 27 and the memory monitor from among components of the display apparatus 20 correspond to the processor 12, the memory 11 and the memory monitor 13 from among components of the electronic apparatus 10 illustrated in FIG. 1, concrete explanations thereon except for portions different from those of the electronic apparatus 10 will be omitted. The components included in the display apparatus 20 are also not limited to the example embodiment described above, but may be implemented as including other additional components.

The display apparatus 20 according to an example embodiment executes programs, such as applications, at a CPU environment which is divided into a general area and a security area. The general area and the security area are divided according to an operating state of the CPU. Different types of OSs may be driven at the general area and the security area, respectively. For instance, an OS, which is sufficiently verified and is strong on security, may be driven in the security area, whereas an OS, which is difficult to verify, but more commonly used, may be driven in the general area. Operations, which are processed at the general area, may include, for example, play back of unencrypted channels, execution of general applications, processing of multimedia data, etc. Also, Operations, which are processed at the security area, may include, for example, processing of important personal information data, processing of encrypted data, etc.

The display apparatus 20 stores in a protection area of the memory 27, data of a first OS and at least one first program involved with the first OS, which are executed at the general area at the CPU environment divided into the general area and the security area. By at least one main processor 25, the display apparatus 20 executes the at least one first program and at least one second program involved with a second OS having an authority higher than the first OS. By the memory monitor 28, the display apparatus 20 detects whether an access to the protection area of the memory 11 occurs and if the access occurs, interrupts the access. Also, by the memory monitor 28, the display apparatus 20 performs a security verification to the data stored in the protection area of the memory 27.

The signal receiver 21 receives a broadcasting signal or an image signal. The signal receiver 21 may be provided in various forms according to standards of the received broadcasting or image signals and implemented types of the display apparatus 20. For instance, the signal receiver 21 may be implemented as a tuner, which receives a radio frequency (RF) broadcasting signal or a satellite signal transmitted from a broadcasting station. As another example, the signal receiver 21 may receive an image signal from external devices, such as a digital versatile disc (DVD) player, a universal serial bus (USB) device and the like, which are connected with the display apparatus 20. As this time, the signal receiver 11 is also not limited to the example embodiment described above, but may receive the broadcasting signal or the image signal in variously implemented forms.

The signal processor 22 performs a predetermined signal processing to the broadcasting signal or the image signal received from the signal receiver 21. Examples of the signal processing, which are performed by the signal processor 22, are decoding, de-interlacing, scaling, noise reduction, detail enhancement, etc. and the types thereof are not limited thereto. The signal processor 22 may be implemented by a system-on-chip (SOC) in which various functions as described above are integrated or an image processing board on which individual components capable of separately performing each process are mounted.

The display 23 displays an image based on the broadcasting signal or the image signal processed by the signal processor 22. Implemented types of the display 23 are not limited, and the display 23 may be implemented in various forms, such as plasma display panel (PDP), liquid crystal display (LCD), organic light emitting diodes (OLED), flexible display, etc.

The user input receiver 24 receives a user input for controlling at least one function of the display apparatus 20. As an example, the user input receiver 24 may be implemented using various input circuitry, such as, for example, a keyboard, a mouse and the like, which are connected with the display apparatus 20, and also implemented in a form of an input panel provided on an outside of the display apparatus 20. As another example, the user input receiver 24 may include a touch screen provided on the display apparatus 20. The touch screen may be configured to detect a touched position, a touched area and a touch input. Also, the touch screen may be configured to detect a proximity touch as well as a real touch. Here, the real touch means a case that a body (for example, a finger) of the user or a touch pen (for example, a pointing device, a stylus, a haptic, an electronic pen, etc.) provided as a touch tool is actually touched on the screen. Also, the proximity touch means a case that the body of the user or the touch pen is not actually touched on the screen, but is approached a preset distance away from the screen (for example, a case that a detectable distance is less than 30 mm).

The communicator 26 may include various communication circuitry that communicates with external apparatuses. The communicator 26 may be connected an external apparatus 29 by a LAN system, such as, BT, Wi-Fi, Zigbee and so on, or by an internet network using TCP/IP. As an example embodiment, if communicating with the external apparatus 29 via the BT, the communicator 26 may be paired with the external apparatus 29 to connect therewith. For instance, the communicator 26 may receive a request for pairing from the external apparatus 29, and recognize the received request to permit a connection therewith. At this time, to permit the connection with the external apparatus 29, the communicator 26 may receive an input, such as a password and the like, from the user via the user input receiver 24.

The memory 27 is provided with a protection area, and stores data of a first OS and at least one first program involved with the first OS, in the protection area. The protection area of the memory 27 may be set as a static memory protection area or a dynamic memory protection area.

The at least one processor 25 executes at least one first program and at least one second program involved with a second OS having an authority higher than the first OS. Here, the at least one first program may be implemented as a general program, which is executed by the first OS at the general area of the CPU. The at least one second program may be implemented as a security required program which is executed by the second OS having an authority higher than the first OS at the security area of the CPU.

The memory monitor 28 detects whether an access to the protection area of the memory 27 occurs and if the access occurs, interrupts the access to the protection area of the memory 27. Also, the memory monitor 28 performs a security verification to data stored in the protection area of the memory 27. As an example embodiment, the memory monitor 28 may implemented by a separate hardware in the display apparatus 20. Since if the memory monitor 28 is implemented by the hardware, there is no data loaded on the memory 27, the memory monitor 28 is more excellent in performance, as compared with if the memory monitor 28 is implemented by a software. Also, if the memory monitor 28 is implemented by the hardware, it is possible to detect alteration or tampering of the memory 27 in real time and to immediately response thereto. However, implemented type of the memory monitor 28 is not limited thereto. For instance, if the CPU is excellent in performance and processing speed, the memory monitor 28 may be implemented by a software, which is executed by the first OS or the second OS.

According to the example embodiment as described above, the display apparatus may guarantee integrity thereof by using the hardware device, which can directly monitor the memory at the CPU environment in which the security area and the general area are separated. Also, if the access to the protection area of the memory occurs, the display apparatus may interrupt the access and perform the security verification at the safe environment.

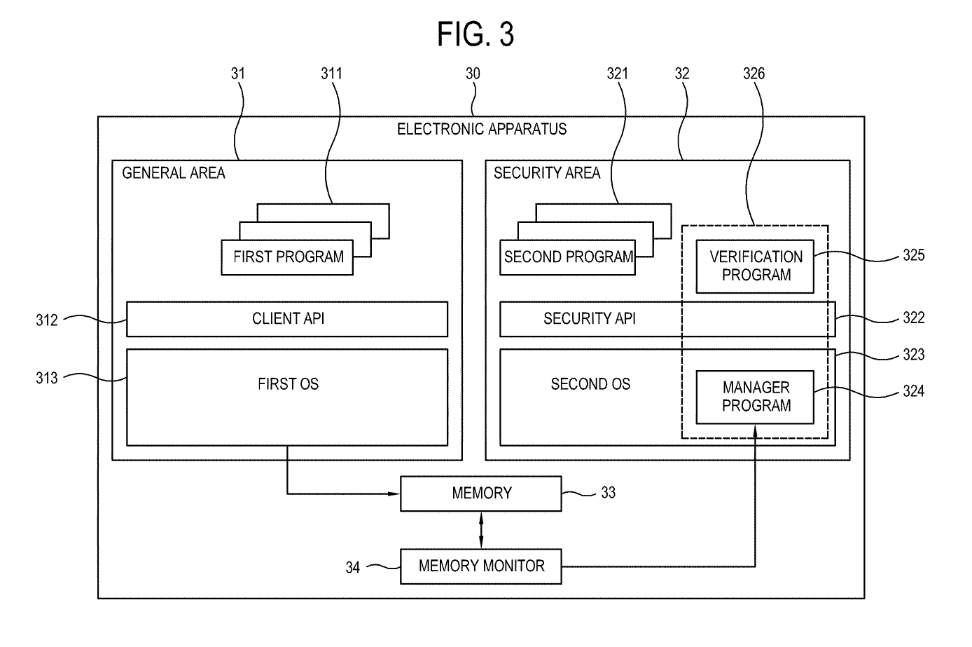

FIG. 3 is a diagram illustrating an example construction for performing memory monitoring and security verification according to an example embodiment. As illustrated in FIG. 3, an electronic apparatus 30 includes at least one processor, a memory 33, and a memory monitor 34. The at least one processor is divided into a general area 31 and a security area 32 and executes at least one program by different OSs in respective areas 31 and 22. The at least one processor executes at least one first program 311 involved with a first OS 313 at the general area 31, and executes at least one second program 321 involved with a second OS 323 at the security area 32. The first OS 313 may be implemented as an OS, which is difficult to verify, but more commonly used and the second OS 323 may be implemented as an OS, which is sufficiently verified and is strong on security.

The at least one first program 311 is implemented as a general program, such as a program for play back of unencrypted channels, a general application, a program for processing of multimedia data, etc., which is executable with a support of the first OS 313. Also, the at least one second program 321 is implemented as a security required program, such as a program for system security, a program for processing of important personal information data, a program for processing of encrypted data, etc., which is executable with a support of the second OS 323.

A client application programming interface (API) 312 is a language, which is used when the at least one first program 311 communicates with the first OS 313 or system program at the general area 31, and may be implemented by calling functions for execution of the first program 311. A security API 322 is a language, which is used when the at least one second program 321 communicates with the second OS 323 or system program at the security area 32, and may be implemented by calling functions for execution of the second program 321.

The memory 33 is provided with a protection area, and stores data of a first OS 313 and at least one first program 311 involved with the first OS 313, in the protection area. The data of the at least one first program 311 stored in the memory 33 may include execution codes and data values related with the at least one first program 311. Since the at least one first program 311 is executed in a kernel environment of the first OS having a low authority in terms of security, there is a potential risk of malicious hacking attempt thereto. It is therefore necessary to monitor whether the data of at least one first program 311 stored the protection area of the memory 33 is altered or tampered, thereby determining whether there is an attack by hacking or the like from the outside.

The memory monitor 34 detects whether an access to the protection area of the memory 33 occurs and if the access occurs, interrupts the access to the protection area of the memory 33. Also, the memory monitor 34 performs a security verification to the data stored in the protection area of the memory 33. As an example embodiment, the memory monitor 34 may implemented by a separate hardware in the electronic apparatus 30. Since if the memory monitor 34 is implemented by the hardware, there is no data loaded on the memory 33, the memory monitor 34 is more excellent in performance, as compared with if the memory monitor 34 is implemented by a software. Also, if the memory monitor 34 is implemented by the hardware, it is possible to detect alteration or tampering of the memory 33 in real time to immediately response thereto.

As an example embodiment, if the access to the protection area of the memory 33 occurs, the memory monitor may transmit information on access occurrence to a security program 326. Here, the information on access occurrence may include an address and a data value for the protection area of the memory 33 that the access has occurred. In other words, if the access, such as read, write, execution and the like, to data stored in the protection area of the memory 33 is detected, the memory monitor 34 may transmit information, such as the address, the data value and the like that the access has been detected, to the security program 326 executed by the second OS 323, thus to perform a security verification at safe environment.

As an example embodiment, the memory monitor 34 may store the information on access occurrence in a register and generate an interrupt request to transmit to the security program 326. For instance, if the access, such as read, write, execution and the like, to data stored in the protection area of the memory 33 is detected, the memory monitor 34 may store an address that the access has been detected in the register and generate a fast interrupt request (FIQ) to transmit to the security program 326. At this time, the security program 326 may read out the address stored in the register based on the FIQ transmitted from the memory monitor 34 and perform a verification on whether there is an attack by hacking or the like, via information for preset verification.

The security program 326 may be executed by a support of the second OS 323 at the security area 32. The security program 326 functions to send and receive information to and from the memory monitor 34 to monitor the protection area of the memory 33, and to perform the security verification. The security program 326 may include a manager program 324, which sends and receives information on the protection area of the memory 33 to and from the memory monitor 34, and a verification program 325, which performs a security verification based on the information on access occurrence transmitted from the memory monitor 34.

As an example embodiment, the manager program 324 may set the protection area of the memory 33 according to a request of the verification program 325. In order words, the manager program 324 may set the protection area of the memory 33 that the memory monitor 34 has to monitor, and transmit information on the set protection area of the memory 33 to the memory monitor 34. Also, the manager program 324 may receive the information on access occurrence to the protection area of the memory 33 from the memory monitor 34, and transmit the received information to the verification program 325 to perform security verification.

As another example embodiment, the manager program 324 may set at least one of a static memory protection area and a dynamic memory protection area according to a request of the verification program 325. As an example, if the static memory protection area is set, the memory monitor 34 may detect whether the protection area of the memory 33 is altered or tampered, thereby verifying whether there is an attack by hacking or the like. As another example, if the dynamic memory protection area is set, the memory monitor 34 may detect whether the protection area of the memory 33 is irregularly altered or tampered, thereby verifying whether there is an attack by hacking or the like.

As an example embodiment, the verification program 325 may request the manager program 324 a setting of the memory protection area of the memory 33, based on the information for setting and verification of the memory protection area of the memory 33 transmitted with being encoded in boot time of the electronic apparatus 30. Also, the verification program 325 may verify whether there is an attack by hacking or the like, based on the information on access occurrence to the protection area of the memory 33 transmitted from the manager program 324. Also, the verification program 325 may generate and store or register a report to the verified result. According to the example embodiment as described, the electronic apparatus may execute the program for security verification at safer CPU environment, thereby guaranteeing integrity to verification environment.

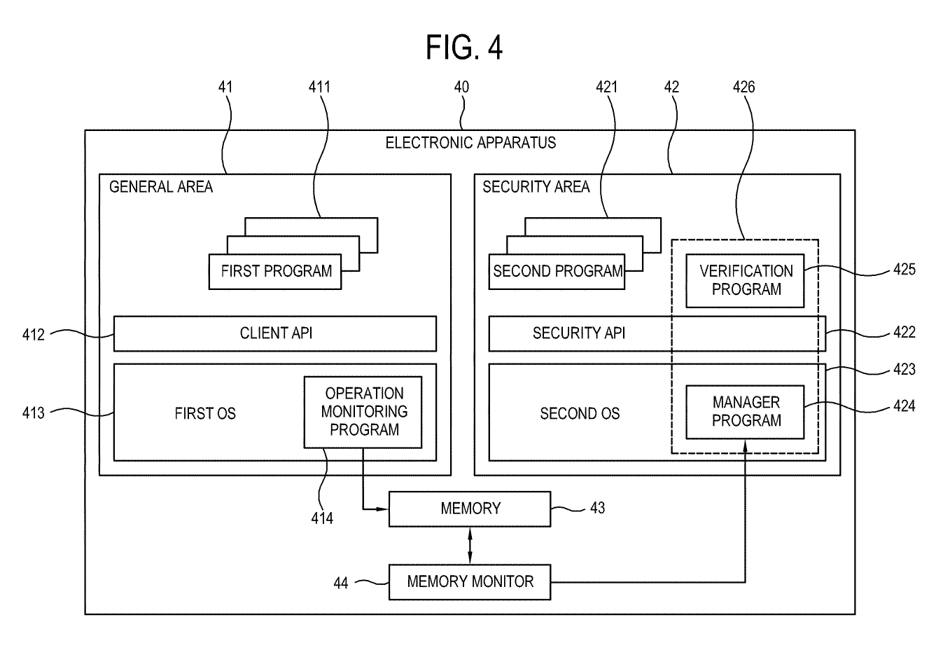

FIG. 4 is a diagram illustrating another example construction for performing memory monitoring and security verification according to an example embodiment. As illustrated in FIG. 4, an electronic apparatus 40 includes at least one processor, a memory 43, and a memory monitor 44. The at least one processor is divided into a general area 41 and a security area 42 and executes at least one program by different OSs in respective areas 41 and 42. Since the at least one processor, the memory 43 and the memory monitor 44 from among components of the electronic apparatus 40 correspond to the at least one processor, the memory 33 and the memory monitor 34 from among components of the electronic apparatus 30 illustrated in FIG. 3, concrete explanations thereon except for portions different from those of the electronic apparatus 30 will be omitted.

The at least one processor executes at least one first program 411 involved with a first OS 413 at the general area 41, and executes at least one second program 421 involved with a second OS 423 at the security area 42.

A client API 412 may be implemented as an interface for enabling the at least one first program 411 to communicate with the first OS 413 or system program at the general area 41, and a security API 422 may be implemented as an interface for enabling the at least one second program 421 to communicate with the second OS 423 or system program at the security area 42.

The memory 43 is provided with a protection area, and stores data of the first OS 413 and the at least one first program 411 involved with the first OS 413, in the protection area.

As an example embodiment, the at least one processor may execute an operation monitoring program 414 by a support of the first OS 413 at the general area 41. The operation monitoring program 414 may set at least one operation on the at least one first program 411, and determine whether the set at least one operation is altered or tampered. In other words, to determine whether specific operations from among a serious of operations performed by the at least one first program 411 are altered or tampered, the operation monitoring program 414 may set at least one operation to be monitored and check the set at least one operation to determine alteration presence. For instance, a netfilter, which is a packet filtering tool provided at a Linux, may process, transmit and manipulate network packets if they come in. However, if any hacker adds malicious filter into the netfilter, it is possible for her or him to attempt an attack, such as intercepting the network packets. Accordingly, to block such an attack, the operation monitoring program 414 may intercept and check main operations from among serious operations performed by the netfilter to verify whether they are altered.

As an example embodiment, the operation monitoring program 414 may set at least one main operation from among a plurality of operations about the at least one first program 411, and if the set main operation is abnormally executed, store or register an address and a data value therefor, in a specific area of the memory 43.

With the execution result of the operation monitoring program 414 as described above, if the memory monitor 44 detects an access to the specific area of the memory 43, the memory monitor 44 may interrupt the access to the specific area of the memory 43. Also, the memory monitor 44 may store the address and the data value that the access is detected, in the register and generate a FIQ to transmit to the manager program 424. At this time, the manager program 424 may read out the address stored in the register based on the FIQ transmitted from the memory monitor 44, to transmit to a verification program 425. The verification program 425 may check a region of the memory 43 for the address transmitted from the manager program 424 to verify whether there is an attack by hacking or the like. Also, the verification program 425 may generate and store or register a report to the verified result.

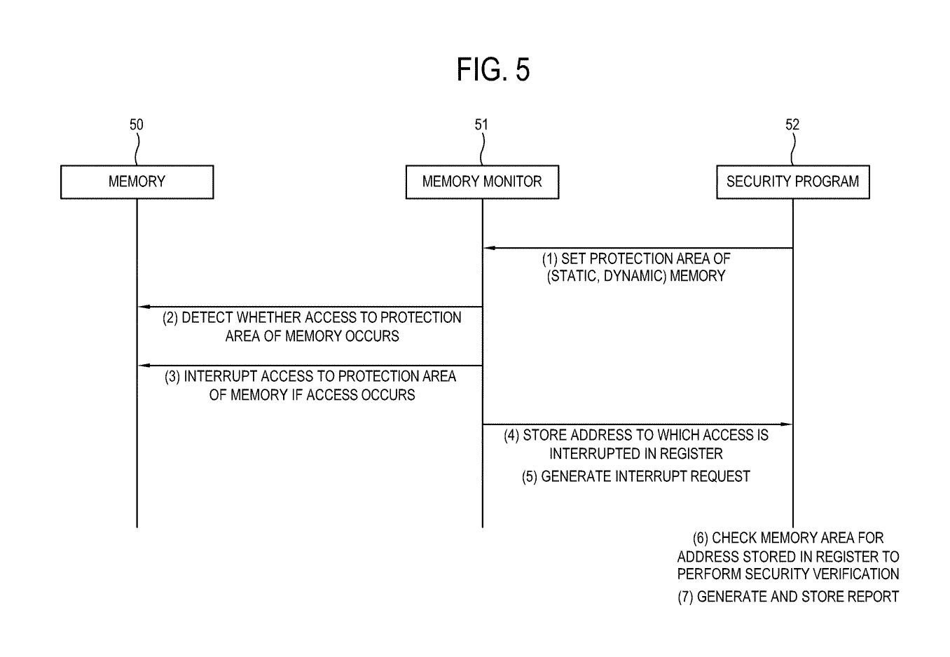

FIG. 5 is a diagram illustrating an example process of performing memory monitoring and security verification according to an example embodiment. As illustrated in FIG. 5, at an operation (1), a security program 52 sets a protection area of the memory 50 which a memory monitor 51 is enabled to monitor. At this time, the protection area of the memory 50 may include a static memory protection area or a dynamic memory protection area. The static memory protection area is an area in which execution codes of a first program executed by a first OS are compiled and stored in boot time of an electronic apparatus, and requires to monitor whether an alteration occurs therein. The dynamic memory protection area is an area in which data of the first program capable of being altered is stored, and requires to monitor whether an abnormal alteration occurs therein. As an example embodiment, the security program 52 may set the protection area of the memory 50 based on information for setting and verification of the protection area of the memory 50 transmitted in an encoded state in boot time of the electronic apparatus.

At an operation (2), a memory monitor 51 detects whether an access to the protection area of the memory 50 occurs. As an example embodiment, if the static memory protection area is set, the access occurrence may be detected by determining whether read, write, execution or the like to data stored in the protection area of the memory 50 occurs. As another example embodiment, if the dynamic memory protection area is set, the access occurrence may be detected by determining whether abnormal write or the like to data stored in the protection area of the memory 50 occurs.

At an operation (3), if the access to the protection area of the memory 50 occurs, the memory monitor 51 denies or interrupts the access. In other words, since the memory monitor 51 according to an example embodiment is implemented by a separate hardware, it may detect the access occurrence to the protection area of the memory 50 in real time thus to immediately interrupt the access. Also, the memory monitor 51 according to an example embodiment may detect even a direct attack to the memory 50 without using page tables, and response thereto.

At an operation (4), the memory monitor 51 stores an address to which the access is interrupted, in a register, and at an operation (5), generates an interrupt request to transmit to a security program 52.

At an operation (6), the security program 52 checks a region or area on the memory 50 for the address stored in the register, based on the interrupt request transmitted from the memory monitor 51, and performs a security verification thereto. At this time, the security verification may be performed based on information for setting and verification of the protection area of the memory 50 transmitted in an encoded state in boot time of the electronic apparatus. At an operation (7), the security program 52 generates and stores a report to the result of the security verification performed at operation (6).

According to the example embodiment as described above, integrity to verification environment may be guaranteed and/or improved by implementing the program for security verification in the safe security area at the CPU environment, which is divided into the security area and the general area. Also, it is possible to immediately detect the alteration of the static memory protection area and the dynamic memory protection area by implementing the separate hardware devices for memory monitoring.

Further, since if the protection area of the memory is altered, information is transmitted in one direction from the general area to the security area, it is possible to reduce a risk of man-in-the-middle attack capable of being generated when transmitting the information in both directions.

Also, by implementing the separate hardware device for memory monitoring, even if the protection area of the memory is altered, it is possible to immediately respond thereto without changing or modifying the OS and even if the electronic apparatus is small in size, it is possible to be applied thereto.

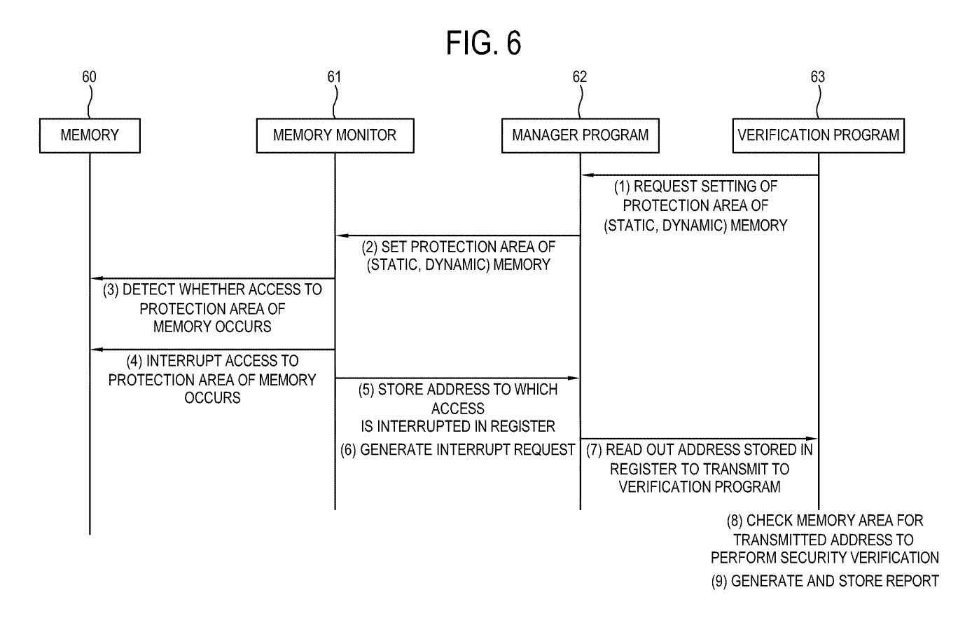

FIG. 6 is a diagram illustrating another example process of performing memory monitoring and security verification according to an example embodiment. As illustrated in FIG. 6, at operation (1), a verification program 63 requests a manager program 62 setting of a protection area of the memory 60. At this time, the protection area of the memory 60 may include a static memory protection area or a dynamic memory protection area. The security verification 63 may request the setting of the protection area of the memory 60, based on information for setting and verification of the protection area of the memory 60 transmitted in an encoded state in boot time of an electronic apparatus.

At an operation (2), the manager program 62 sets the protection area of the memory 60 which the memory monitor 61 is enabled to monitor, based on the request of the verification program 63.

At an operation (3), a memory monitor 61 detects whether an access to the protection area of the memory 60 occurs. As an example, the access occurrence may be detected by determining whether read, write, execution or the like to data stored in the protection area of the memory 60 occurs.

At an operation (4), if the access to the protection area of the memory 60 occurs, the memory monitor 61 denies or interrupts the access. In other words, since the memory monitor 61 according to an example embodiment is implemented by a separate hardware, it may detect the access occurrence to the protection area of the memory 60 in real time thus to immediately interrupt the access.

At an operation (5), the memory monitor 61 stores an address to which the access is interrupted, in a register, and at an operation (6), generates an interrupt request to transmit to a manager program 62.

At an operation (7), the manager program 62 reads out the address stored in the register based on the interrupt request transmitted from the memory monitor 61, to transmit to the verification program 63.

At an operation (8), the verification program 63 checks a region or area on the memory 60 for the address transmitted from the manager program 62 to perform a security verification thereto. At this time, the security verification may be performed based on information for setting and verification of the protection area of the memory 60 transmitted in an encoded state in boot time of the electronic apparatus. At an operation (9), the verification program 63 generates and stores or registers a report on the result of the security verification performed at operation (8).

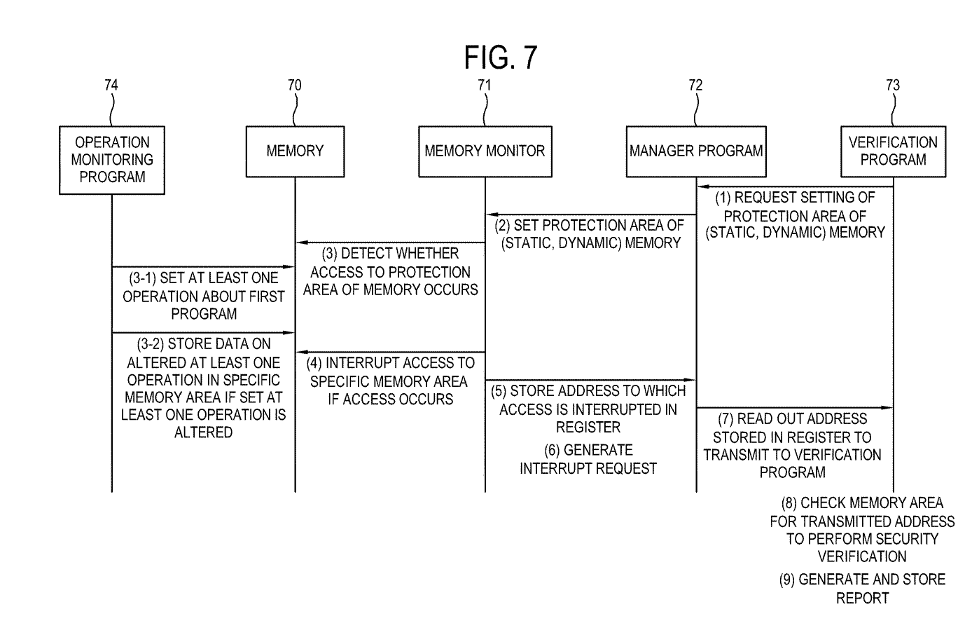

FIG. 7 is a diagram illustrating another example process of performing memory monitoring and security verification according to an example embodiment. As illustrated in FIG. 7, at operation (1), a verification program 73 requests a manager program 72 a setting of a protection area of the memory 70. At this time, the protection area of the memory 70 may include a static memory protection area or a dynamic memory protection area. The security verification 73 may request the setting of the protection area of the memory 70, based on information for setting and verification of the protection area of the memory 70 transmitted in an encoded state in boot time of an electronic apparatus.

At an operation (2), the manager program 72 sets the protection area of the memory 70 which the memory monitor 71 is enabled to monitor, based on the request of the verification program 73. At this time, the manager program 72 transmits information on the set protection area of the memory 70.

At an operation (3), a memory monitor 71 detects whether an access to the protection area of the memory 70 occurs. As an example, the access occurrence may be detected by determining whether read, write, execution or the like to data stored in the protection area of the memory 70 occurs.

At an operation (3-1), an operation monitoring program 74 sets at least one operation on at least one first program, and at an operation (3-2), if the set at least one operation is altered, stores data on altered at least one operation in a specific memory area of the memory 70.

At an operation (4), with the execution result of the operation monitoring program 74, if the memory monitor 71 detects the access to the specific memory area of the memory 70, the memory monitor 71 denies or interrupts the access to the specific memory area.

At an operation (5), the memory monitor 71 stores an address to which the access is interrupted, in a register, and at an operation (6), generates an interrupt request to transmit to a manager program 72.

At an operation (7), the manager program 72 reads out the address stored in the register based on the interrupt request transmitted from the memory monitor 71, to transmit to the verification program 73.

At an operation (8), the verification program 73 checks a region or area on the memory 70 for the address transmitted from the manager program 72, and performs a security verification thereto. At this time, the security verification may be performed based on information for setting and verification of the protection area of the memory 70 transmitted in an encoded state in boot time of the electronic apparatus. Lastly, at an operation (9), the verification program 73 generates and store or registers a report on the result of the security verification performed at operation (8).

According to the example embodiment as described above, it is possible to detect alteration presence to a specific operation from among a plurality of operations about the at least one program executed at the general area of the CPU, thereby determining whether there is an attack by a third program.

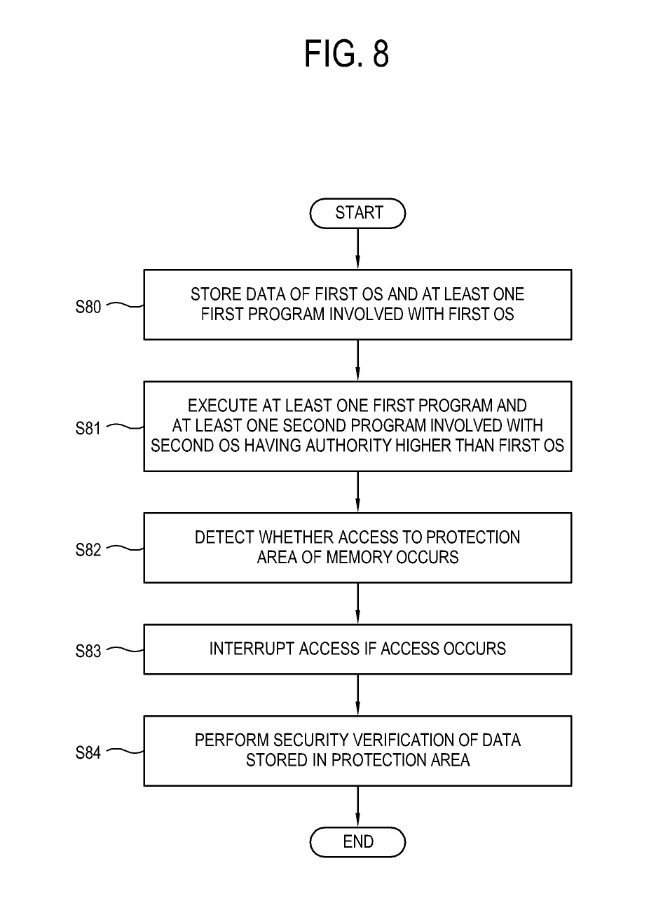

FIG. 8 is a flowchart illustrating an example control method of an electronic apparatus according to an example embodiment. As illustrated in FIG. 8, at an operation S80, the electronic apparatus stores data of a first OS and at least one first program involved with the first OS in a protection area of a memory. The first OS as an OS driven at a general area of a CPU corresponds to an OS, which is difficult to verify, but more commonly used. The first OS may be implemented as, for example, a Linux. The at least one first program as a general program executable by a support of the first OS may be implemented as, for example, a program for play back of unencrypted channels, a general application, a program for processing of multimedia data, etc.

Since codes and data related with the at least one first program stored in the protection area of the memory runs a risk of malicious hacking attack, it is necessary to monitor such a hacking attack.

At an operation S81, at least one processor executes the at least one first program and at least one second program involved with a second OS having an authority higher than the first OS. The second OS as an OS driven at a security area of the CPU may be implemented as an OS, which is sufficiently verified and strong on security. The at least one second program as a security required program executable by a support of the second OS may include, for example, a program for system security, a program for processing of important personal information data, a program for processing of encrypted data, etc. Like this, the general program and the security required program are executed at OS environments having different authorities, respectively, thereby implementing safe security environment.

At an operation S82, a memory monitor detects whether an access to the protection area of the memory occurs, and at an operation S83, if the access to the protection area of the memory occurs, denies or interrupts the access. At this time, the access occurrence may be detected by determining whether read, write, execution or the like to data stored in the protection area of the memory occurs. Also, since the memory monitor is implemented as a separate hardware to monitor the memory, it is possible to interrupt the access to the protection area of the memory in real time if the access occurs.

As an example embodiment, the at least one processor may execute a security program for monitoring the protection area of the memory. At this time, at the operation S82, if the access to the protection area of the memory occurs, the memory monitor may transmit information on access occurrence to the security program. The information on access occurrence may include an address and a data value for the protection area of the memory that the access has occurred. Also, at the operation S82, the memory monitor may store the information on access occurrence in a register and generate an interrupt request to transmit to the security program. Lastly, at an operation S84, a security verification of data stored in the protection area of the memory is performed.

As an example embodiment, the security program may be implemented including a manager program, which sends and receives information on the protection area of the memory to and from the memory monitor, and a verification program, which performs a security verification based on the information on access occurrence transmitted from the memory monitor. Also, the security program may be executed by a support of the second OS, thereby enabling the security verification to perform in safer environment.

As an example embodiment, the control method may include setting the protection area of the memory according to a request of the verification program, by the manager program. At this time, the protection area of the memory may include at least one of a static memory protection area and a dynamic memory protection area. The setting of the protection area of the memory may be requested by the verification program, based on information for setting and verification of the protection area of the memory transmitted to the security area in an encoded state in boot time of the electronic apparatus.

As an example embodiment, the control method may include, by the at least one processor, setting at least one operation on at least one first program and executing an operation monitoring program, which determines whether the set at least one operation is altered or tampered. If the set at least one operation is altered, the operation monitoring program may store or register data on the altered at least one operation in a specific memory area. With the execution result of the operation monitoring program as described above, if the memory monitor detects an access to the specific area of the memory, the memory monitor may interrupt the access to the specific area of the memory.

While various example embodiments have been illustrated and described with reference to various examples and figures, it will be understood by those skilled in the art that various changes in form and details may be made therein without departing from the spirit and scope of the present disclosure as defined by the appended claims and their equivalents.

What is claimed is:

1. An electronic apparatus comprising:
a memory comprising a protection area and configured to store data of a first operating system (OS) and at least one first program involved with first OS in the protection area;
at least one processor configured to execute the at least one first program and at least one second program involved with a second OS having an authority higher than the first OS; and
a memory monitor comprising circuitry configured to:
to detect whether an access to the protection area of the memory occurs;
to interrupt the access if the access occurs; and
to perform a security verification of the data stored in the protection area.

2. The apparatus according to claim 1, wherein the at least one processor is configured to execute a security program to monitor the protection area of the memory.

3. The apparatus according to claim 2, wherein the memory monitor is configured to transmit information on access occurrence to the security program if the access to the protection area of the memory occurs.

4. The apparatus according to claim 3, wherein the information on access occurrence comprises an address and a data value of the protection area of the memory to which the access has occurred.

5. The apparatus according to claim 3, wherein the memory monitor is configured to store the information on access occurrence in a register and to generate an interrupt request to transmit to the security program.

6. The apparatus according to claim 3, wherein the security program comprises:
a manager program configured to send and receive information on the protection area of the memory to and from the memory monitor; and
a verification program configured to perform security verification based on the information on access occurrence transmitted from memory monitor.

7. The apparatus according to claim 2, wherein the security program is executed by support of the second OS.

8. The apparatus according to claim 6, wherein the manager program is configured to set the protection area of the memory based on a request of the verification program.

9. The apparatus according to claim 8, wherein the manager program is configured to set at least one of: a static memory protection area and a dynamic memory protection area based on the request of the verification program.

10. The apparatus according to claim 1, wherein the at least one processor is configured to set at least one operation of the at least one first program and to execute an operation monitoring program configured to determine whether the set operation is altered.

11. A control method of an electronic apparatus comprising:
storing data of a first operating system (OS) and at least one first program involved with first OS in a protection area of a memory;
executing, by at least one processor, the at least one first program and at least one second program involved with a second OS having an authority higher than the first OS; and
detecting whether an access to the protection area of the memory occurs;
interrupting the access if the access occurs; and
performing a security verification of the data stored in the protection area.

12. The method according to claim 11, wherein the at least one processor is configured to execute a security program for monitoring the protection area of the memory.

13. The method according to claim 12, further comprising: transmitting information on access occurrence to the security program if the access to the protection area of the memory occurs.

14. The method according to claim 13, wherein the information on access occurrence comprises: an address and a data value of the protection area of the memory to which the access has occurred.

15. The method according to claim 13, further comprising: storing the information on access occurrence in a register and generating an interrupt request to transmit to the security program.

16. The method according to claim 13, wherein the security program comprises:
a manager program configured to send and receive information on the protection area of the memory to and from the memory monitor; and
a verification program configured to perform security verification based on the information on access occurrence transmitted from memory monitor.

17. The method according to claim 12, wherein the security program is executed by support of the second OS.

18. The method according to claim 16, further comprising setting the protection area of the memory based on a request of the verification program.

19. The method according to claim 18, further comprising: setting at least one of a static memory protection area and a dynamic memory protection area based on the request of the verification program.

20. The method according to claim 1, further comprising: setting at least one operation of the at least one first program and executing an operation monitoring program, which determines whether the set operation is altered.
